(19) United States
(12) Patent Application Publication
(10) Pub. No.: US 2005/0268773 A1
(43) Pub. Date: Dec. 8, 2005

(54) Apparatus and method for pitch training

(76) Inventor: Marietta Miller, Washington, DC (US)

Correspondence Address: Marietta Miller, 66 Adams St. N.W., Washington, DC, 20001, US

(21) Appl. No.: 10/862,229

(22) Filed: Jun. 5, 2004

(51) Int. Cl. G09B 15/06

(52) U.S. Cl. 84/466

(57) ABSTRACT

An apparatus for pitch training comprising a display with multiple display sections. Each display section is assigned to a note of a musical scale and is controlled by a controller section. By observing the display sections and reproducing the note of the musical scale when the corresponding display section lights up, persons will learn to recognize the pitch of the various notes of the musical scale.

### FIELD OF THE INVENTION

The present invention is in the field of music and more specifically to a novel apparatus and method for musical pitch training.

### BACKGROUND OF THE INVENTION

For decades it has been thought that the ability to recognize the different musical pitches that comprise modern music was a skill that could not be taught. While various attempts have been made to teach musical pitch, none of the methods currently in use provide an easily accessible method that utilizes the abilities of most people to differentiate differences in pitch. There is therefore a need for apparatus and method that teach the ability to recognize and reproduce different musical pitch. The instant invention addresses this need.

### SUMMARY OF THE INVENTION

The instant invention describes an apparatus and method for using said apparatus for pitch training. The apparatus comprises a display comprising a plurality of display sections and each of the plurality of display sections corresponds to a note of a musical scale. A controller section is connected to the display such that the controller section controls the illumination of each of the display sections. In an embodiment of the invention, each display section comprises at least two sections. In a further embodiment, each display section is assigned a unique color.

In using the apparatus, a separate note of a musical scale is assigned to each of the display sections, and individuals will reproduce each separate note of the musical scale as each of the corresponding display sections lights up. The individual can reproduce the notes by singing the notes or playing the notes on a musical instrument.

### BRIEF DESCRIPTION OF THE DRAWINGS

For a more complete understanding of the present invention and the advantages thereof, reference is now made to the following description taken in conjunction with the accompanying drawings, wherein like reference numerals represent like features, in which:

FIG. 1 is a block diagram of an embodiment of the instant invention.

FIG. 2 is a block diagram of a further embodiment of the instant invention.

FIG. 3 is a block diagram of a further embodiment of the instant invention.

FIG. 4 is a block diagram of a further embodiment of the instant invention.

### DETAILED DESCRIPTION OF THE INVENTION

Referring to FIG. 1, the apparatus of the instant invention comprises at least one display 10 and associated controller sections 100. In an embodiment of the instant invention, the display 10 comprises a housing 20 containing at least eight display sections C1, C2, C3, C4, C5, C6, C7, C8, at least one additional display section 30, and at least one sound producing device 35. Each of the at least eight display sections is further divided into sections a and b.

In describing the apparatus and method of the instant invention, the display sections will be designated by referring to the display sections C1 through C8 and then differentiating between sections a or ab. Using the above described designation scheme, one would refer to display C2a or C6ab. Display C2a indicates that the only the “a” section of display C2 will light. In other words, C2a indicates that only the “a” half of the display C2 will light up. Display C6ab indicates that both the “a” and “b” halves of the C6 display will light up simultaneously. In other words, C6ab indicates that the entire C6 display will light up.

The display sections C1 through C8 will light up in the same or different colors in response to input signals from the controller sections 100. In an embodiment where the display sections C1 through C8 are the same color, that color could be white, red, blue, green, etc, or any other suitable color. In an embodiment where the display sections C1 through C8 are different colors, any color can be used to form each display section. For example, C1 could be red, C2 yellow, C3 green, C4 purple, C5 blue, C6 orange, C7 white, can C8 black. In a further embodiment, the “a” portion of a given display section can be assigned a first color different from a second color that can be assigned to the display sections “a” and “b” when both sections of the display light up simultaneously. It should be understood that the assignment of the various colors to each display section C1 through C8 is not limited to any particular order and many different possibilities exist. The instant invention should therefore not be limited to the above described example of assigning various colors to the display section. The instant invention is intended to encompass any assignment of colors to the various display sections C1 through C8. In the instant invention, the term “light(s) up” refers to a change in the state of the various display sections C1 through C8. Before a given display section lights up, the display section will emanate photons at a first intensity I₁. When the display section lights up, the display section will emanate photons at a second intensity I₂, where I₂ is greater than I₁. The frequency of the photons emanated from the display sections will depend on the color of the given display section. The difference in the intensities I₂ and I₁ should be such that a clearly discernable difference in brightness should be visible to the naked eye of a person with average vision when a display section lights up.

Although the apparatus of the instant invention can be used in all types of music, the method of the instant invention will be described with reference to the western musical scale. The extension to other musical scales will also be described.

In most Western music, melodies are composed of sections in which the seven notes of the diatonic scale are used, corresponding to the seven notes with letter names. The degrees of the scale, which are the notes considered relative to the tonic of the musical piece being played, or within the key of that piece are named as follows:

TABLE 1

| | | Corresponds to notes: | | | | | | | | | | | | Mode starting here: |
|---|---|---|---|---|---|---|---|---|---|---|---|---|---|---|
| Do | Tonic | C | G | D | A | E | B | C | F | Bb | Eb | Ab | Db | Major (Ionian) |
| Re | Supertonic | D | A | E | B | F# | C# | D | G | C | F | Bb | Eb | Dorian |
| Mi | Mediant | E | B | F# | C# | G# | D# | E | A | D | G | C | F | Phrygian |
| Fa | Subdominant | F | C | G | D | A | E | F | Bb | Eb | Ab | Db | Gb | Lydian |
| So | Dominant | G | D | A | E | B | F# | G | C | F | Bb | Eb | Ab | Mixolydian |
| La | Submediant | A | E | B | F# | C# | G# | A | D | G | C | F | Bb | Minor (Aeolian) |
| Ti | Subtonic | B | F# | C# | G# | D# | A# | B | E | A | D | G | C | Locrian |

thus, “the note that corresponds to C” is the Tonic, “the note that corresponds to D” is the Supertonic, and so on. The column with E at the top illustrates the notes in the scale of E major. The set of notes used for the key of C major is also the set of notes used for the key of A minor. Major and minor are examples of modes, and the final column gives the name of the mode with that degree of the diatonic scale as its tonic.

With regards to the display 10 in FIG. 1, the display section C1 corresponds to Do or the tonic of any given scale, the display section C2 corresponds to Re or the supertonic of the scale, and so on. Table 2 shows the relationship between the display sections C1 through C8 and the diatonic scale.

TABLE 2

| | | Pitch | Frequency | Display Section |
|---|---|---|---|---|
| Do | Tonic | P1 | F1 | C1 |
| Re | Supertonic | P2 | F2 | C2ab |
| Mi | mediant | P3 | F3 | C3ab |
| Fa | Subdominant | P4 | F4 | C4a |
| So | Dominant | P5 | F5 | C5ab |
| La | Submediant | P6 | F6 | C6ab |
| Ti | Subtonic | P7 | F7 | C7ab |
| Do* | Tonic | P8 | F8 | C8a |

*This is an octave above the starting note or pitch C1.

Starting with the tonic, the display C1 will always light up in its entirety. The second note of the diatonic scale is a whole step above the tonic and therefore both halves of the C2 display will light up simultaneously (or C2ab) to represent the note of the Supertonic or Re. The mediant or Mi is a whole step above the supertonic and therefore both halves of the C3 display (or C3ab) will light up simultaneously. The subdominant is a half step above the mediant and now only the lower half of the C4 display (or C4a) will light up to represent the half step. The dominant is a full step above the subdominant and both halves of the C5 display (or C5ab) will light up simultaneously to represent the whole step. The submediant is a whole step above the dominant and both halves of the C6 display (or C6ab) will light up simultaneously to represent the whole step. The subtonic is a whole step above the submediant and both halves of the C7 display (or C7ab) will light up simultaneously to represent the whole step. The tonic is a half step above the subtonic and now only the lower half of the C8 display (or C8a) will light up to represent the half step. In this way the diatonic scale can be represented in the display sections C1 through C8.

In a general way, the display sections C1 through C8 can be described as representing the different pitches that correspond to any musical scale. Each pitch corresponds to notes of a different frequency. Referring to Table 2, the first note Do will correspond to a first pitch P1 at a first frequency F1 that will depend on the key to which the scale corresponds. Therefore a scale in the key of G will have a different first frequency F1 compared to the first frequency F1 of a scale in the key of C. The remaining notes in a given key will have pitches and frequencies that have a predetermined relationship to the first pitch P1 and frequency F1. The second note Re will correspond to a second pitch P2 at a second frequency F2 that is greater that F1. The third note Mi will correspond to a third pitch P3 at a third frequency F3 that is greater than F2. The fourth note Fa will correspond to a fourth pitch P4 at a fourth frequency F4 that is greater than F3. The fifth note So will correspond to a fifth pitch P5 at a fifth frequency F5 that is greater than F4. The sixth note La will correspond to a sixth pitch P6 at a sixth frequency F6 that is greater than F5. The seventh note Ti will correspond to a seventh pitch P7 at a seventh frequency F7 that is greater than F6. Finally the eighth note Do will correspond to an eighth pitch P8 at an eighth frequency F8 that is an octave above the first frequency F1. The display sections C1 through C8 therefore correspond to the different pitches and frequencies of any musical scale.

In using the display 10, persons will look at the various display sections (C1 through C8) while listening to the various pitches of the notes corresponding to a given musical scale. By equating the relative pitch of each note of the musical scale with the spatial relationship of the various display sections (C1 through C8) as they light up, an individual or person will learn to recognize the absolute pitch of each note and the relative pitch of each note in relation to the tonic or any other note of the scale. The various pitches corresponding to the notes can be produced in the sound producing device 35 or any other suitable device. In a further embodiment of the instant invention, individuals can sing or play on any musical instrument the pitch or note on a given scale that corresponds to the display section that lights up or is illuminated (light up and illuminate can be used interchangeably). For example in the key of F, an individual would sing or play the note D if the display section C6ab is illuminated. The display section 30 can light up in steady meter (or tempo) or varying meter (or tempo) corresponding to a predetermined number of beats per minute in varying time signatures such as 4/4, ¾, ⅚, 7/16, etc., to set the desired meter or tempo for the display sections. The use of the display 30 is optional and the display 30 can light up in any color. In a further embodiment, an audible sound or click can be used to indicate the required tempo or desired meter. The sound can emanate from any device capable of producing such sound. Such devices include speakers, piezo electric crystals, metal ribbons, and the sound producing device 35 shown in FIG. 1. The sound can vary in loudness to indicate the beats that should be emphasized or accented in the varying time signatures.

Although the diatonic scale was used to illustrate the method of using the display 10 to learn absolute and relative pitch, it should be noted that any scale can be represented on the display 10. Any order of whole or half steps can be represented by illuminating half of any display section (e.g., C5a) to represent a half step above the previous note (e.g., C4a or C4ab) or simultaneously illuminating both halves of the display section (e.g., C5ab) to represent a whole step above the previous note (e.g. C4a or C4ab).

In operation, the display sections C1 through C8 are connected to 40 and controlled by a controller section 100. As shown in FIG. 1, the controller section 100 comprises a memory section for storing programmed sequences that determine the order in which the various display sections light up. The memory section is connected 160 to a driver section 140 that is comprised of at least two different sections 142 and 144. The driver section will comprise a trigger section 142 that will output control signals 42 to cause the various display sections C1 through C8 to light up. The driver section 140 will further comprise a micro-control section 144 that will receive input signals 44 stored in the memory section 180 or input signals 46 from an input section 120. The micro-control section will interpret the various input signals 44 and/or 46 and supply that necessary input signal 48 to the driver section 142 that then produces the necessary output signals 42. Commands can be inputted to either store a sequence in the memory section 180 or control the display sections C1 through C8 and 30 and/or the sound producing device 35 simultaneously with the inputting of a control signal (i.e., control the display sections C1 through C8 and 30 in real time).

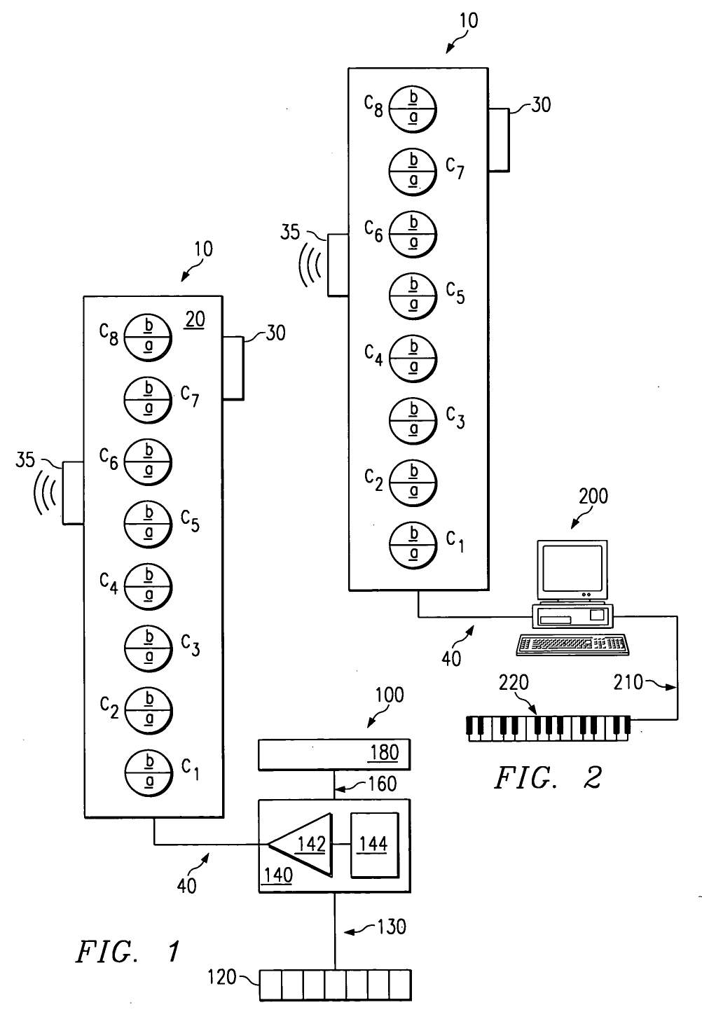

A further embodiment of the instant invention is shown in FIG. 2. In FIG. 2, a digital computer 200 or similar device is used to control the display sections C1 through C8 and 30. A traditional musical instrument such as a electronic keyboard or electronic piano 220 can be connected 210 to the computer 200 to provide the input signals. The keyboard 220 can be connected to the computer using established means and protocols such a MIDI. The keyboard 220 can be used to create a program that will be stored in the digital computer 220 and used to control the sequence in which the display sections C1 through C8 and 30 light up. The keyboard can also be used to cause the display sections C1 through C8 and 30 to light up in real time. It should be noted that any traditional music instrument can be used to input signals to the digital computer 200.

In use, an individual can program a sequence into the digital computer 200 using the keyboard 220, a conventional computer keyboard, a computer mouse, or any other means suitable for programming the digital computer 200. The digital computer can then be used to control the sequence in which the various display sections light up when the previously entered program is run on the digital computer 200. In this way, any number of sequences can be stored in the digital computer 200 for use at any given time.

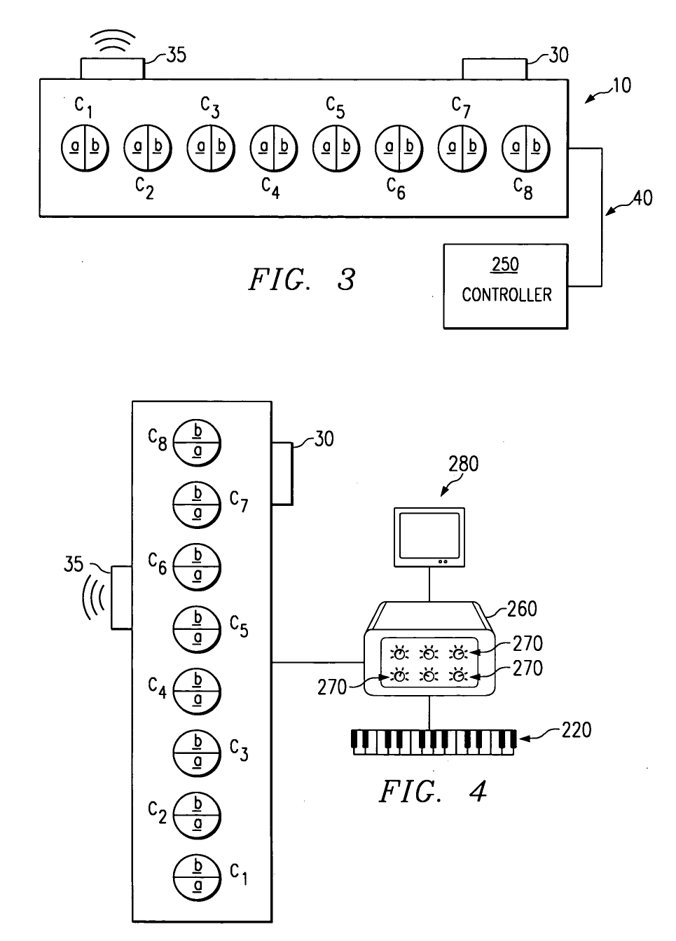

Shown in FIG. 3 is a further embodiment of the instant invention. As shown in FIG. 3, the display section 10 is oriented in a horizontal manner compared to the vertical orientation shown in FIG. 1 and FIG. 2. The display section C6 in FIG. 3 will represent a pitch higher than the pitch represented by display C5. In a similar manner the pitch represented by C5 will be higher than the pitch represented by C4. Therefore in the display 10 orientation shown in FIG. 3, increasing pitch is represented by moving through the various display sections C1 through C8 from left to right. A control section 250 is connected to the display section 10 to control the sequence in which the display sections C1 to C8 light up as well as the sound of the pitch of the notes corresponding to the various display sections C1 through C8 as they light up. The control section 250 can be any suitable device capable of controlling the display section 10.

Shown in FIG. 4 is a further embodiment of the instant invention. A controller 260 is connected to the display 10. The controller 260 comprises a plurality of controls 270 that can be used to set a meter corresponding to a predetermined number of beats per minute in varying time signatures such as 4/4, ¾, ⅚, 7/16, etc. The controls 270 will control the display 30 and/or the sound producing device 35. In use, the controls 270 can be used to set the sound producing device 35 and/or the display 30 to produce any number of beats per minute in any time signature (i.e. any tempo). A keyboard 220 can be used in conjunction with the controller 260 to determine the sequence in which the displays C1 through C8 will light up. In addition to the keyboard 220, any suitable input device can be used to control the displays C1 through C8. In addition, a second controller 280 capable of storing a predetermined display sequence can be used to control the sequence in which the displays C1 through C8 light up.

While this invention has been described with reference to illustrative embodiments, this description is not intended to be construed in a limiting sense. Various modifications and combinations of the illustrative embodiments, as well as other embodiments of the invention will be apparent to persons skilled in the art upon reference to the description. It is therefore intended that the appended claims encompass any such modifications or embodiments.

1. Pitch training apparatus, comprising:
a display comprising a plurality of display sections wherein each of said plurality of display sections corresponds to a note of a musical scale; and
a controller section connected to said display wherein said controller section controls the illumination of each of said plurality of display sections.

2. The pitch training apparatus of claim 1 further comprising a sound producing device that emits a pitch of said note of said musical scale when a display section of said plurality of display sections corresponding to said note illuminates.

3. The pitch training apparatus of claim 2 wherein each of said plurality of said display sections comprises a different color.

4. The pitch training apparatus of claim 1 wherein said controller section comprises an electronic keyboard.

5. The pitch training apparatus of claim 1 wherein said controller section comprises a digital computer.

6. The pitch training apparatus of claim 1 further comprising an additional display that can display a steady meter or a varying meter.

7. The pitch training apparatus of claim 2 further comprising a sound producing device that emits sound corresponding to a steady or a varying meter.

8. The pitch training apparatus of claim 6 wherein said controller section comprises at least one control that can be used to set a meter corresponding to a predetermined number of beats per minute in varying time signatures.

9. The pitch training apparatus of claim 7 wherein said control section comprises at least one control that can be used to set a meter corresponding to a predetermined number of beats per minute in varying time signatures.

10. A music pitch training apparatus, comprising:
a display comprising:
a plurality of display sections each of which comprises a different color wherein each of said plurality of display sections corresponds to a note of a musical scale;
a controller section connected to said display wherein said controller section controls the illumination of each of said plurality of display sections; and
a sound producing device that emits a pitch of said note of said musical scale when a display section of said plurality of display sections corresponding to said note illuminates.

11. The pitch training apparatus of claim 10 wherein each of said plurality of said display sections comprises at least two sections.

12. The pitch training apparatus of claim 10 further comprising an additional display that can display a steady meter or a varying meter.

13. The pitch training apparatus of claim 10 further comprising a sound producing device that emits sound corresponding to a steady or a varying meter.

14. A method of using musical pitch training apparatus, comprising:
assigning a note of a musical scale to each display section of a plurality of display sections; and
reproducing said note of said musical scale as the assigned display sections lights up.

15. The method of claim 14 further comprising inputting into a controller section the order in which each display section light up.

16. The method of claim 15 further comprising inputting into said controller section a tempo in which each display section will light up.

17. The method of claim 14 wherein said reproducing of said note is performed by singing said note.

18. The method of claim 14 wherein said reproducing of said note is performed on a musical instrument.

19. The method of claim 14 further comprising listening to the pitch of the note of the musical scale corresponding to each display section of the plurality of display sections as the assigned display sections lights up
